(19) United States
(12) Patent Application Publication
(10) Pub. No.: US 2012/0215439 A1
(43) Pub. Date: Aug. 23, 2012

(54) More accurate navigation method

(75) Inventor: Stephen Chen, Changhua (TW)

(73) Assignee: E-LEAD ELECTRONIC CO., LTD.

(21) Appl. No.: 12/929,855

(22) Filed: Feb. 22, 2011

(51) Int. Cl. G01C 21/00

(52) U.S. Cl. 701/412; 701/416

(57) ABSTRACT

A more accurate navigation method allowing the user to check the destination information online with personal computer and then performs steps of settings, searching and modifying the destination position on the website, draws the route inside the large destination from entrance to the final parking space, downloads the edited data and import the data to the navigation device by external transmission device. The navigation device is therefore capable of navigating the users to an approximate destination position and then accurately navigating the users to the specific parking space that is closest to the final destination.

### BACKGROUND OF THE INVENTION

1. Field of the Invention

The present invention relates to a more accurate navigation method; and more particularly, to a more accurate navigation method that is capable of not only navigating the users to an approximate position of the destination but accurately navigating the users to the parking space of the final destination.

2. Brief Description of the Related Art

The existing navigation device is generally used by the users inputting the destination address or searching famous attractions or landmarks data built in the device system. This way, the navigation device can only navigate the vehicle to an approximate position of the destination. As for smaller destinations such as general residence houses or stores, this may not seem to be a big problem; however, when the destination is a building inside a campus or a large factory area, or a parking lot disposed in the wild countryside, the foregoing navigation device can only lead the vehicle to the entrance of the destination (such as the school gate) and after that, it is up to the user to find his way to the specific building or parking space that he wants to reach.

Some of the manufacturers provide a navigation device that is capable of adjusting the destination position after inputting the address; however, owing to the map shown on the small display screen of the navigation device being limited and the operation interface thereon being inconvenient, it is difficult for the users to adjust the destination position. Further, the users are not familiar with the landform of the destination to make appropriate adjustment.

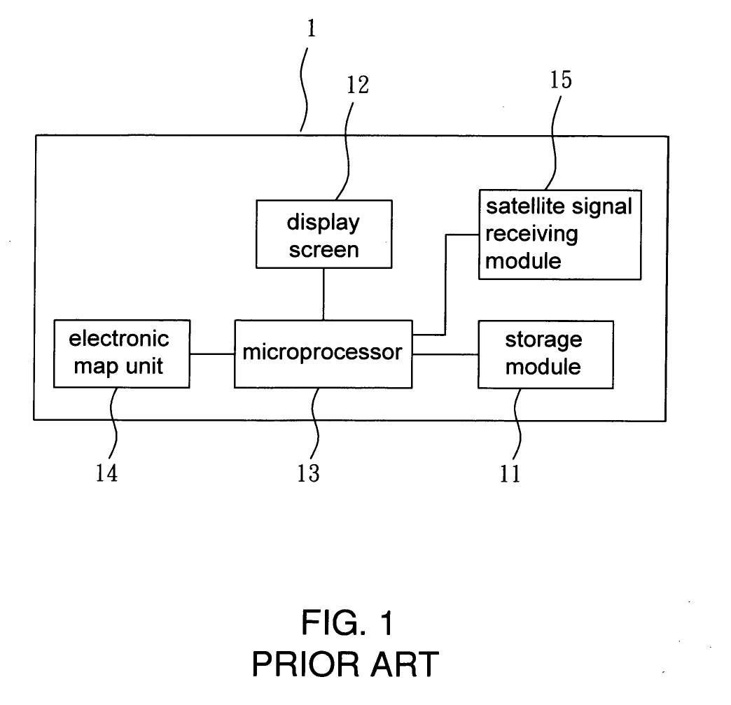

To solve the foregoing deficiencies, the industry has provided inventions to navigate the users to the parking space closest to the final destination. The inventions are mostly of the two methods described below.
(1) Directly modifying the route on the navigation device, such as Taiwan Patent No. 1274303, 1305886 and 1314694. Referring to FIG. 1, the navigation device 1 of this kind of prior art comprises a storage module 11, a display screen 12, a microprocessor 13, an electronic map unit 14 and a satellite signal receiving module 15. Wherein map data is provided by the electronic map unit 14 to the microprocessor 13 and shown on the display screen 12. As a constant is inputted to the electronic map unit 14, a mark point is thereby provided on the map and route modification is thereby activated. This method is capable of accurately navigating the users to the parking space closest to the final destination; however, the map data of the navigation device 1 cannot be easily updated and therefore when the landform or roads have changed, this method is no longer useful.
(2) Searching for detailed information of the destination (addresses, map blocks, electronic maps) by the internet and map data to provide to the users as reference and thereby increases navigation efficiency. Similar prior art includes Taiwan Patent No. 1282843, 1287389, 1291015 and M337728 etc. This method assists the navigation by continuously searching for information online and sometimes does achieve the goal of leading the users to the parking space closest to the final destination. However, when the related information is inadequate, the navigation result cannot be perfect and the users still have to look for the parking space closest to the final destination themselves.

The navigation method of the foregoing prior art relies on the users to adjust the destination position themselves and requires complex setting process. If the users are not familiar with the destination and can only set the system by guessing, the navigation accuracy can be poor. Moreover, even the entrance of the destination is correctly provided, users still need to ask for the way or to find the way themselves to the parking space closest to the destination.

### SUMMARY OF THE INVENTION

In order to overcome the deficiencies of the prior art, a primary object of the present invention is to provide a more accurate navigation method that is capable of not only navigating the users to an approximate position of the destination but accurately navigating the users to the parking space of the final destination.

With the above object in mind, the present invention comprises a website with map data and editing software to allow the user to edit destination file thereon, and a navigation device capable of reading the destination file. The destination file comprises at least the name, the longitude and latitude coordinate and map or satellite image of the destination. Wherein the navigation method of the present invention comprises at least the steps described hereinafter.
Step a: providing a website with map data and editing software; user input the name and address of the destination on the website and thereby generates a mark point on the map thereof, and the longitude and latitude coordinate of the mark point position is then recorded.
Step b: allowing the user to adjust the mark point position, and automatically updating the longitude and latitude coordinate of the mark point position after the adjustment.
Step c: allowing the user to make marks or draw routes on the map or satellite image.
Step d: packing the destination file for the user to download or send out, wherein the destination file comprises at least the name, the coordinate and map or satellite image of the destination.
Step e: importing the destination file to the navigation device, and performing navigation according to the longitude and latitude coordinate position.
Step f: displaying the map or satellite image on the screen when reaches the destination.

By the foregoing method, the user is allowed to check the destination information online with personal computer and then performs steps of settings, searching and modifying the destination position on the website, draws the route inside the large destination from entrance to the final parking space, downloads the edited data and import the data to the navigation device by external transmission device; the navigation device is therefrom capable of navigating the users to an approximate position and then accurately navigating the users to the parking space closest to the final destination.

The website of the present invention is capable of performing at least the steps described hereinafter:
Step 1: providing a website with map data and editing software; user input the name and address of the destination on the website and thereby generates a mark point on the map thereof, and the longitude and latitude coordinate of the mark point position is then recorded.
Step 2: allowing the user to adjust the mark point position, and automatically updating the longitude and latitude coordinate of the mark point position after the adjustment.
Step 3: allowing the user to make marks or draw routes on the map or satellite image.
Step 4: packing the destination file for the user to download or send out, wherein the destination file comprises at least the name, the coordinate and map or satellite image of the destination.

The navigation device of the present invention is capable of performing at least the steps described hereinafter:
Step 1: importing the destination file to the navigation device, and performing navigation according to the longitude and latitude coordinate position.
Step 2: displaying the map or satellite image on the screen when reaches the destination.

Wherein the map or satellite image of the present invention has at least three points with longitude and latitude coordinate thereon; and by the longitude and latitude coordinates of the points and the vehicle's current position, the vehicle's current position is thereby being marked on the image.

### BRIEF DESCRIPTION OF THE INVENTION

The detail structure, the applied principle, the function and the effectiveness of the present invention can be more fully understood with reference to the following description and accompanying drawings, in which:

FIG. 1 is a block diagram of navigation device according to the prior art;

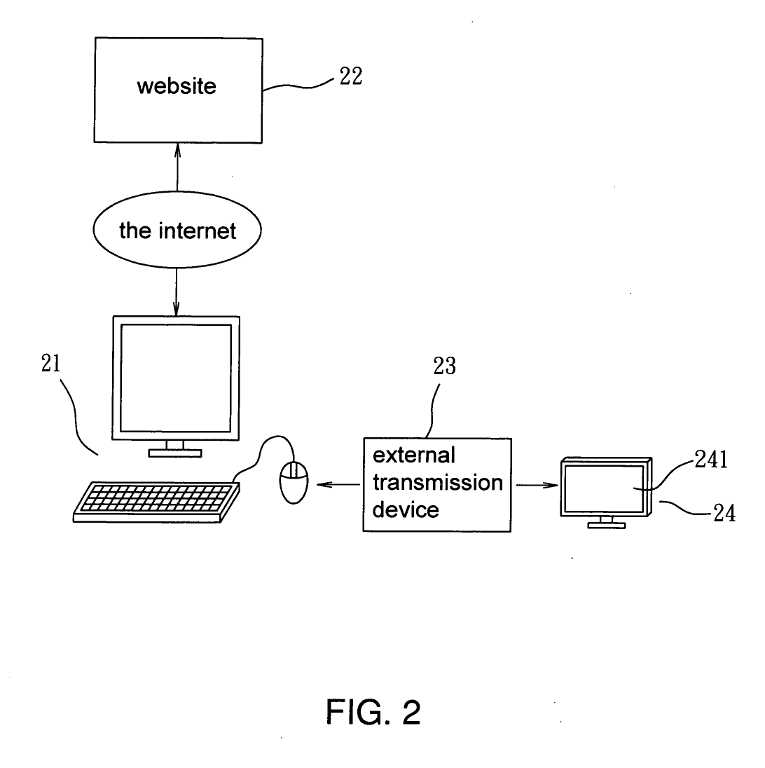

FIG. 2 illustrates the hardware structure system according to the present invention;

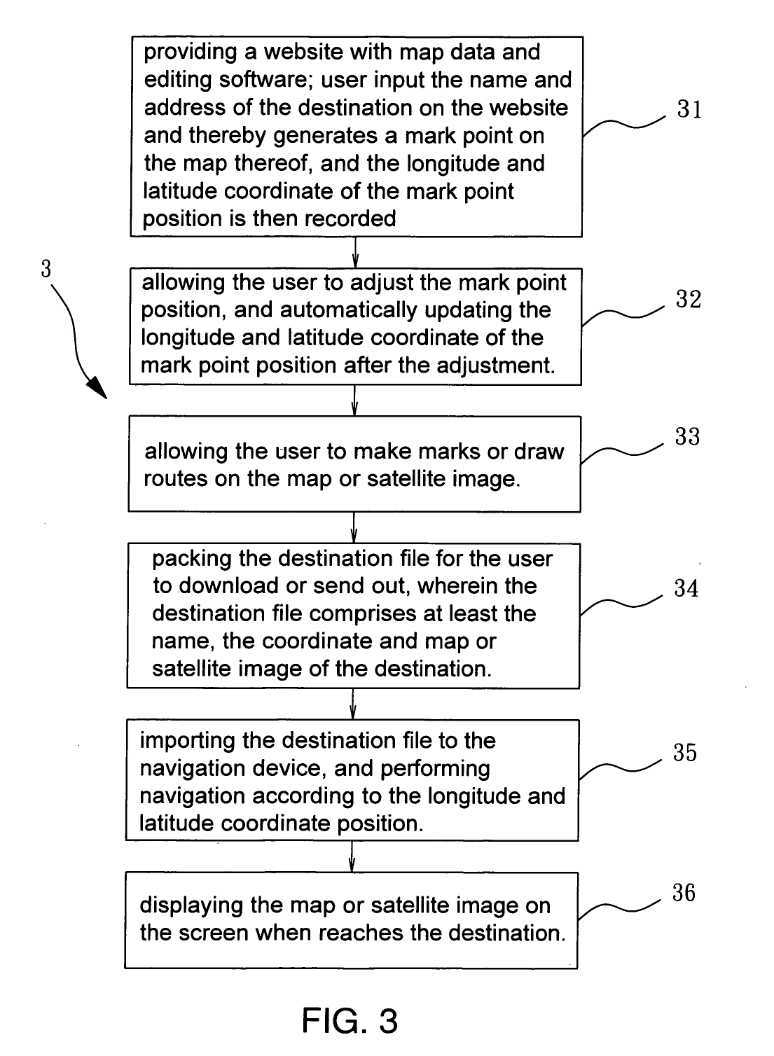

FIG. 3 is a flow chart of the navigation method according to the present invention;

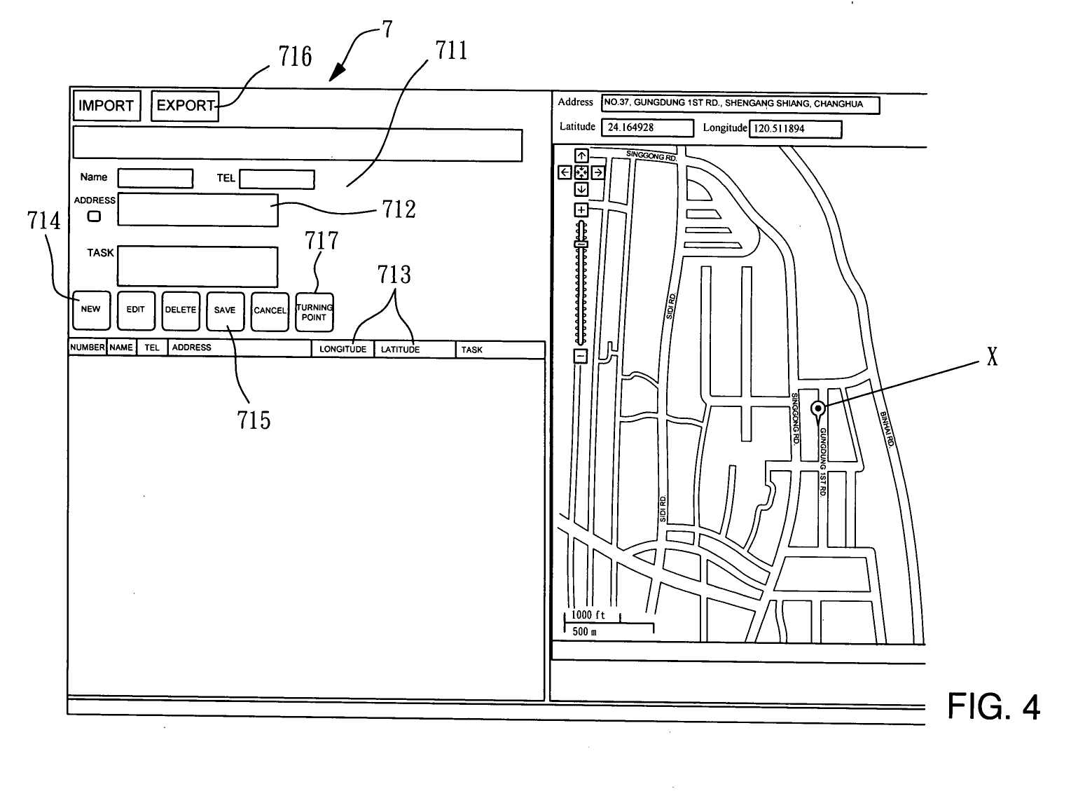

FIG. 4 is a first operation schematic representation according to the present invention;

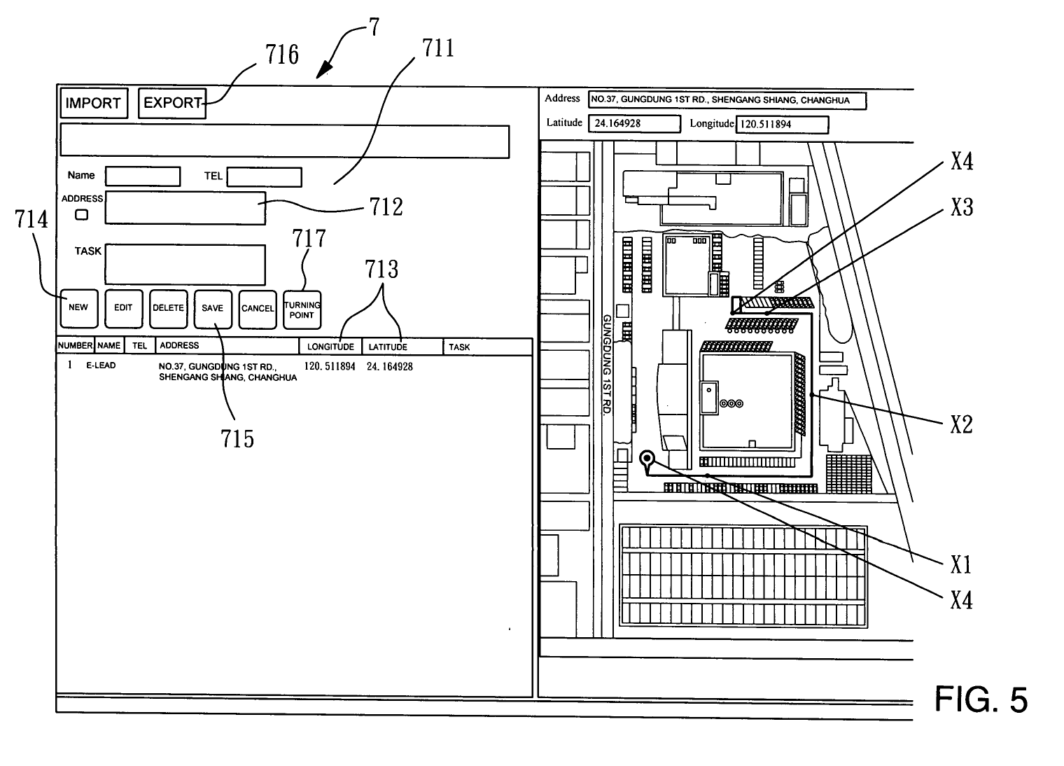

FIG. 5 is a second operation schematic representation according to the present invention;

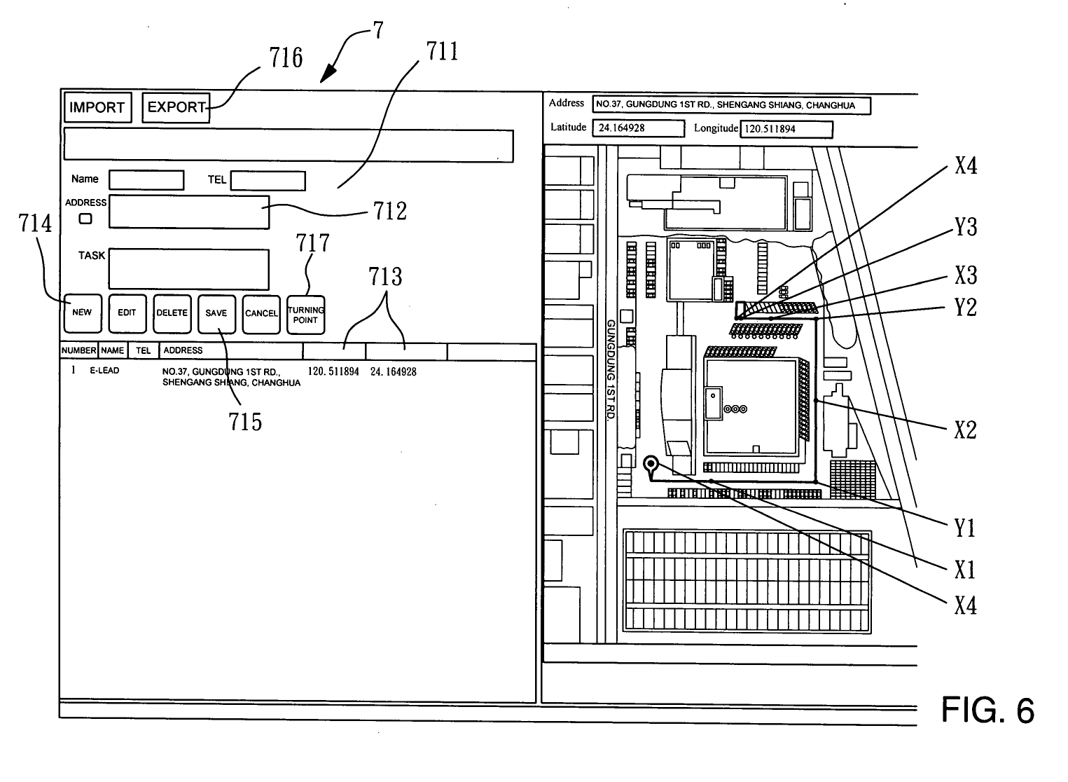

FIG. 6 is a third operation schematic representation according to the present invention;

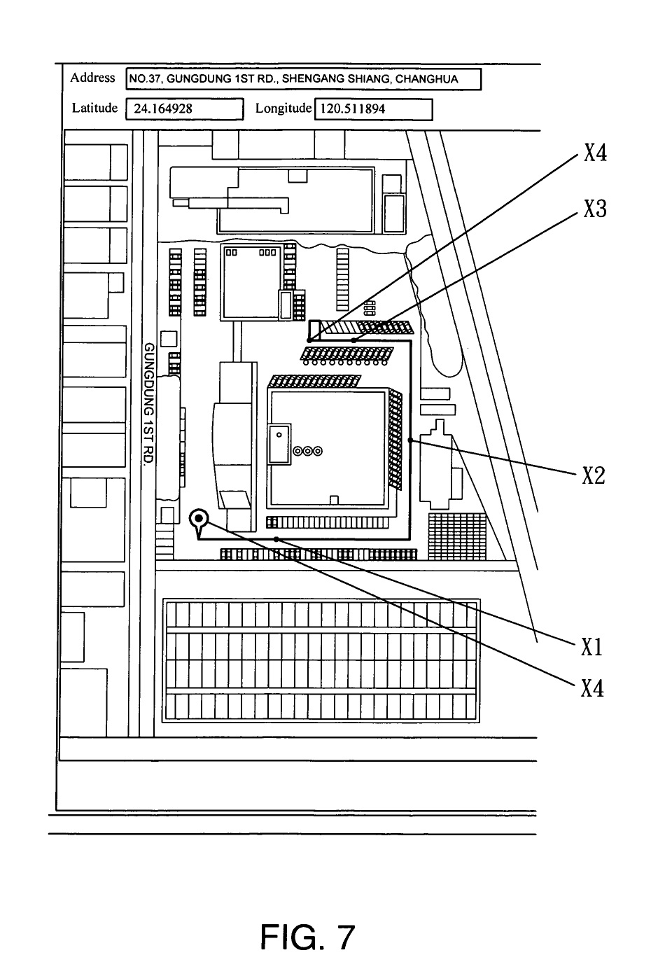

FIG. 7 is a fourth operation schematic representation according to the present invention; and

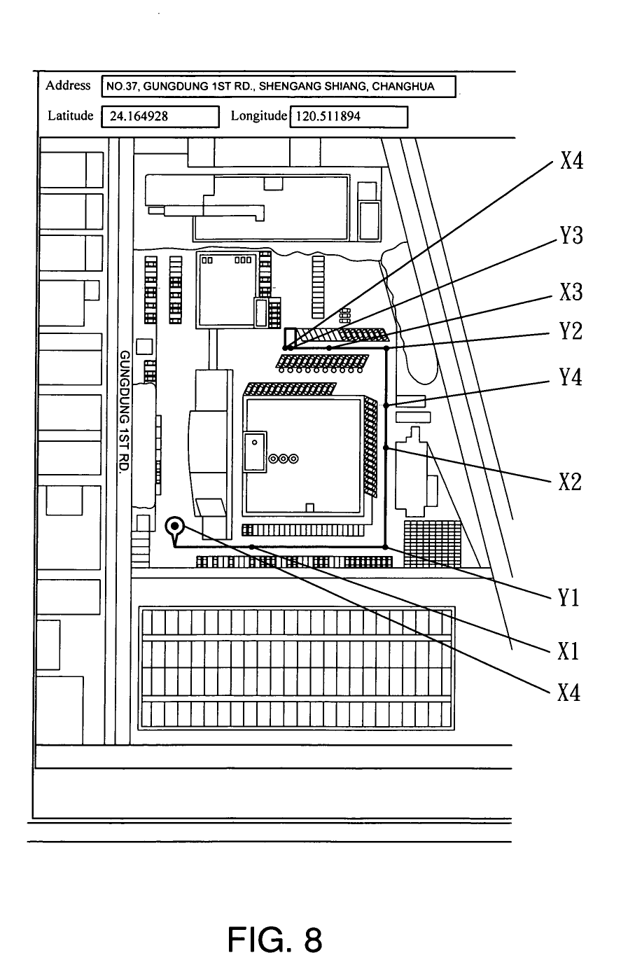

FIG. 8 is a fifth operation schematic representation according to the present invention.

### DETAILED DESCRIPTION OF THE PREFERRED EMBODIMENTS

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

Referring to FIG. 2, wherein the hardware structure system according to the present invention comprises:
a personal computer 21 capable of connecting to the interne;
a website 22 with map data and editing software;
an external transmission device 23 being an USB or a SD card, wherein the external transmission device 23 is capable of transmission and storing data; and
a navigation device 24 comprising a display screen 241, wherein the navigation device 24 is capable of reading the data stored in the external transmission device 23.

Under the foregoing hardware structure, navigation method 3 of the present invention is capable of navigating more accurately; wherein the navigation method 3 comprises a website 22 with map data and editing software to allow the user to edit destination file thereon, and a navigation device 24 capable of reading the destination file. The destination file comprises at least the name, the longitude and latitude coordinate and map or satellite image of the destination. Wherein the navigation method 3 of the present invention comprises at least the steps described hereinafter.
Step 31: providing a website with map data and editing software; user input the name and address of the destination on the website and thereby generates a mark point on the map thereof, and the longitude and latitude coordinate of the mark point position is then recorded.
Step 32: allowing the user to adjust the mark point position, and automatically updating the longitude and latitude coordinate of the mark point position after the adjustment.
Step 33: allowing the user to make marks or draw routes on the map or satellite image.
Step 34: packing the destination file for the user to download or send out, wherein the destination file comprises at least the name, the coordinate and map or satellite image of the destination.
Step 35: importing the destination file to the navigation device, and performing navigation according to the longitude and latitude coordinate position.
Step 36: displaying the map or satellite image on the screen when reaches the destination.

Wherein, the Step 31 allows the user to connect to a website 22 by the interne. The website 22 with map data and editing software is capable of storing the longitude and latitude data to allow the user to extract to their personal computer 21 and then displaying the map of nearby area of the longitude and latitude coordinate and providing a mark point thereon. Therefore, as the user click on “NEW” 714 on the input webpage 7, as illustrated in FIG. 4, a form filling interface 711 is automatically performed; after the filling of address 712, the user can click on “SAVE” 715 to upload the data to the website 22. The website 22 then updates the longitude and latitude coordinate data and stores the new data into the database; wherein the longitude and latitude coordinate field 713 corresponding to the address then makes a mark point on the map showing the address position X.

Wherein, the Step 32 allows the user to adjust the address position X, and the website 22 then automatically updates the corresponding longitude and latitude coordinate thereof after the adjustment.

Wherein, the Step 33 allows the user to draw routes (X1, X2 and X3) or make mark (X4) on the map or satellite image, as illustrated in FIG. 5.

Wherein, the Step 34 allows user to click on “EXPORT” 716 and the website 22 therefrom packs the destination file for the user to download to their external transmission device; the destination file comprises at least the name, the coordinate and map or satellite image of the destination.

Since the map or satellite image downloaded from the website 22 is only an image file and does not contain longitude and latitude data like the original electronic map, the current position of the vehicle cannot be determined. However, the map or satellite image that the present invention provides has at least three points with longitude and latitude coordinates thereon; and by the longitude and latitude coordinates of the points and the vehicle's current position, the vehicle's current position is capable of being marked on the image.

Referring to FIG. 6, after the user draws routes X1, X2 and X3 and makes mark X4 on the map or satellite image in the Step 33, the user can click on “TURNING POINT” 717 on the electronic map to obtain the longitude and latitude coordinate thereof; at least three route turning points Y1, Y2 and Y3 is therefrom marked in the electronic map. By using the three route turning points Y1, Y2 and Y3, it is able to determine the longitude and latitude data of the whole area within the map or satellite image file; further, as illustrated in FIG. 8, by comparing the route turning points Y1, Y2 and Y3 to the longitude and latitude coordinate of the current vehicle position provided by the GPS in the vehicle, it is able to locate the current vehicle position in the map or satellite image.

The foregoing Steps 31-34 are also capable of being completed by people other than the driver. Such as, the person that the driver wishes to visit should be someone who knows the destination well. Therefore, the person could go on the website 22 to input the name and address of the destination, and adjust the mark point on the electronic map to the entrance of the destination. Then, the person could further draw the route inside the destination area (such as a large factory area) on the map or satellite image. The person could then save and send the destination file to the driver; the driver could simply import the destination file to the navigation device 24 with the external transmission device 23 such as an USB, and the navigation device 24 can automatically perform Steps 35 and 36 without any further settings requirement. As the vehicle reaches the destination area, the navigation device 24 will show the image file of the destination file on the display screen, as illustrated in FIG. 7. The driver is then capable of driving to the mark point X4 of the specific parking space close to the final destination according to the route X1, X2 and X3.

The website 22 of the present invention is capable of performing at least the steps described hereinafter:
Step 1: providing a website 22 with map data and editing software; user input the name and address of the destination on the website and thereby generates a mark point on the map thereof, and the longitude and latitude coordinate of the mark point position is then recorded.
Step 2: allowing the user to adjust the mark point position, and automatically updating the longitude and latitude coordinate of the mark point position after the adjustment.
Step 3: allowing the user to make marks or draw routes on the map or satellite image.
Step 4: packing the destination file for the user to download or send out, wherein the destination file comprises at least the name, the coordinate and map or satellite image of the destination.

The navigation device 24 of the present invention is capable of performing at least the steps described hereinafter:
Step 1: importing the destination file to the navigation device 24, and performing navigation according to the longitude and latitude coordinate position.
Step 2: displaying the map or satellite image on the screen when reaches the destination.

I claim:

1. A more accurate navigation method comprising a website with map data and editing software to allow user to edit destination file thereon, and a navigation device capable of reading the destination file, wherein the destination file comprises at least name, longitude and latitude coordinate and map or satellite image of the destination; wherein, the navigation method of the present invention comprises at least the following steps:
Step a: providing a website with map data and editing software; user input the name and address of the destination on the website and thereby generates a mark point on the map thereof, and the longitude and latitude coordinate of the mark point position is then recorded;
Step b: allowing the user to adjust the mark point position, and automatically updating the longitude and latitude coordinate of the mark point position after the adjustment;
Step c: allowing the user to make marks or draw routes on the map or satellite image;
Step d: packing the destination file for the user to download or send out, wherein the destination file comprises at least the name, the coordinate and map or satellite image of the destination; and
Step e: importing the destination file to the navigation device, and performing navigation according to the longitude and latitude coordinate position.

2. The more accurate navigation method as described in claim 1, wherein the website is capable of performing at least the following steps:
Step 1: providing a website with map data and editing software; user input the name and address of the destination on the website and thereby generates a mark point on the map thereof, and the longitude and latitude coordinate of the mark point position is then recorded;
Step 2: allowing the user to adjust the mark point position, and automatically updating the longitude and latitude coordinate of the mark point position after the adjustment;
Step 3: allowing the user to make marks or draw routes on the map or satellite image; and
Step 4: packing the destination file for the user to download or send out, wherein the destination file comprises at least the name, the coordinate and map or satellite image of the destination.

3. The more accurate navigation method as described in claim 1, wherein the navigation device is capable of performing at least the following steps:
Step 1: importing the destination file to the navigation device, and performing navigation according to the longitude and latitude coordinate position; and
Step 2: displaying the map or satellite image on the screen when reaches the destination.

4. The more accurate navigation method as described in claim 1, wherein the map or satellite image has at least three points with longitude and latitude coordinate thereon; and by the longitude and latitude coordinates of the points and the vehicle's current position, the vehicle's current position is thereby being marked on the image.

5. The more accurate navigation method as described in claim 1, wherein the navigation method further comprises:
Step f: displaying the map or satellite image on the screen when reaches the destination.
